(19) United States
(12) Patent Application Publication
(10) Pub. No.: US 2020/0000294 A1
(43) Pub. Date: Jan. 2, 2020

(54) SKIN CLEANSING APPLIANCE USING TAPPING AND OSCILLATING ACTION OF A HEAD MEMBER PORTION

(71) Applicant: L'Oreal, Paris (FR)

(72) Inventor: Robert E. Akridge, Seattle, WA (US)

(21) Appl. No.: 16/021,384

(22) Filed: Jun. 28, 2018

(51) Int. Cl. A47K 7/04; A61Q 19/10

(52) U.S. Cl. CPC A47K 7/04; A46B 13/008; A61Q 19/10

(57) ABSTRACT

The appliance includes a driving unit in combination with a head portion. The head portion includes a stiff base part and a flexible application part. The driving unit moves the head portion in a back and forth action, toward and away from the skin, providing a depth of cleansing by stretching the skin in a depth, i.e. vertical, direction into the skin, as well an oscillating action in the plane of the skin, stretching the skin in that direction, providing cleansing actions in perpendicular directions.

### TECHNICAL FIELD

This invention relates generally to skin cleansing appliances and more specifically to appliances which involve a moving head portion responsive to a driving force.

### BACKGROUND OF THE INVENTION

Typically, power skin brushes utilize an oscillating bristle action, with the oscillating action being generally in the plane of the skin. The oscillating action stretches the skin bi-directionally, at a selected frequency and amplitude, producing cleansing of the skin, although such action usually does not produce optimal cleansing and does not have any additional skin enhancing effects.

### SUMMARY OF THE INVENTION

Accordingly, the invention is a skin cleansing appliance, comprising; a driving assembly; a head portion having a base member which is attachable to the driving assembly; the head portion further having a flexible applicator assembly for holding a skin formulation; a driving assembly for moving the head portion back and forth producing an action on the skin, stretching the skin in the skin depth direction; and further for oscillating the head portion when the flexible applicator assembly is in contact with the skin.

### BRIEF DESCRIPTION OF THE DRAWINGS

FIG. 1 is an elevational view of the appliance which includes a moving head member.

FIG. 2 is an end view of the head member.

FIG. 3 is an elevational view showing an alternative configuration of the head member.

FIG. 4 is an elevational view of a configuration with multiple head members in a single unit.

FIG. 5 is an end view of the unit of FIG. 4.

FIG. 6 is an elevational view of a head member having an end configuration adapted for cleansing around particular facial features.

FIG. 7 is a cross sectional view of an alternative head member arrangement.

### BEST MODE FOR CARRYING OUT THE INVENTION

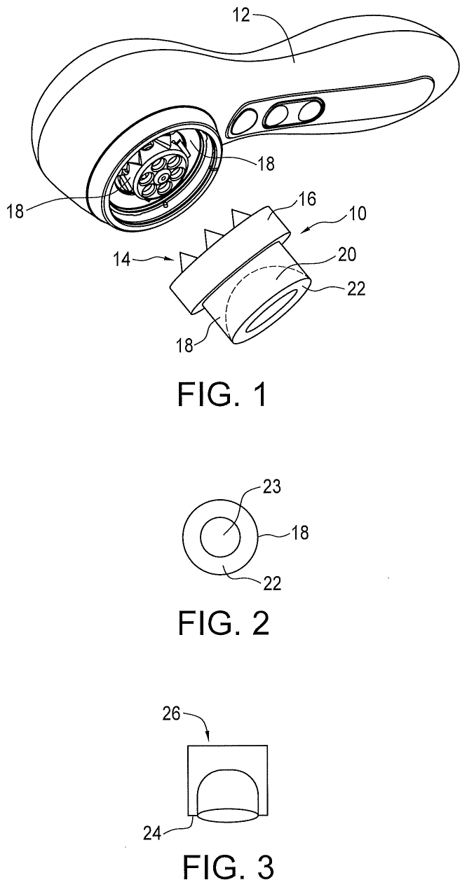

FIG. 1 shows a removable head member 10 in combination with a driving unit 12 to form a skin cleansing appliance 14. The driving unit 12 may take various configurations. It is adapted to receive and mechanically connect to the head member 10 by various arrangements, including for instance attachment elements 14-14 on the head member 10 and mating receiving elements 18-18 on the driving unit. Other arrangements, however, can be used, such as are known in various skin cleansing devices having removable heads, either for different cleansing effects or for replacement.

The head 10 includes a base portion 16 which is typically made of stiff, hard plastic approximately 1 inch thick and a diameter of approximately 2½ inches, although the dimensions can vary. The base portion 16, plastic or other material, is stiff to provide a solid base for the operative action of the head. Extending outwardly from the base 16 is a soft, flexible member 18. The flexible member 18 may be rubber or sponge or other flexible material. The flexible member 18 includes a central cavity 20 which is designed to hold a skin formulation or a combination of formulation and water. End surface 22 is in the form of a doughnut, with a center opening 23 having a diameter of approximately ¼ inch, although this can be varied. The width of the end surface in the embodiment shown is approximately ¼ inch or less, which also can be varied. A narrow end surface embodiment 26 is shown in FIG. 3, again adapted to hold a dose of skin formulation. Typically, cavity 20 (FIG. 1) contains sufficient formulation to treat a selected area of the skin, such as a discoloration area.

One primary action provided by the drive unit 12 is a back and forth action, typically perpendicular to the driving unit and hence to the skin. The action is often referred to as a tapping action, with a frequency in the range of 150-170 Hz, and an amplitude of 6°-12°, although these values can be varied. The action could be also at a small angle relative to the skin, such as 20° or less. The tapping action of the head 10 in the embodiment shown provides an effective deep cleansing effect on the skin, as it stretches the skin vertically, i.e. into the depth of the skin.

The drive unit can also be controlled to provide an alternate oscillation action, in the plane of the skin, similar to conventional skin brush action. The actions could alternate, with the same time duration, and the same frequency, although the time duration of each action could be different as well as the respective frequencies, i.e. the frequency of the oscillation could be different than the frequency of the tapping action. The dual action results in a stretching and cleansing of the skin in the vertical direction, i.e. the depth of the skin and laterally, the surface of the skin.

Further, the action could be a movement to the skin, contacting the skin, in a tapping action, or not, followed by an oscillation, and then back to a position away from the skin; i.e. move toward the skin, tap the skin, oscillate and then back to a position away from the skin.

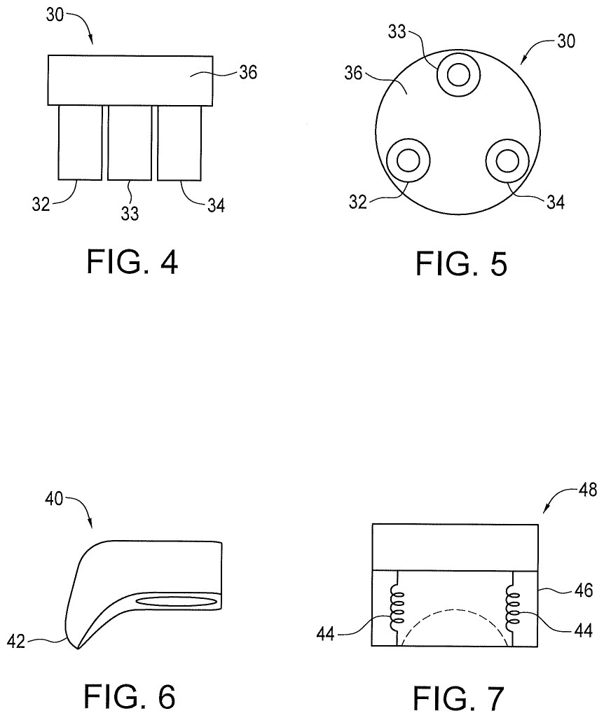

More than one head could be configured in a single unit, as shown in FIGS. 4 and 5, at 30, which includes three separate heads 32, 33 and 34, extending from a base unit 35. Each head can be controlled independently so they can move separately, together, or in combination. Each head has the same action described above; move to the skin, oscillate for a selected time and then move away from the skin. The head could also have a particular configuration such as shown in FIG. 6 at 40, with one end portion 42 being higher than the remaining portion. This could be used for instance to treat skin around the nose area.

The arrangement could also include a spring or springs 44 in the sponge/flexible part 46 of the head 48, which would aid in the tapping action, as shown in FIG. 7. Further, as indicated briefly above, the head can be positioned relative to the driving unit such that the tapping action is not perpendicular to the skin, but at a selected angle, i.e. within the range of 5°-20°. The angle could be adjustable to provide a slightly different cleansing effect.

In addition to the cleansing effect, the tapping action produces a massage sensation on the skin, so that the use of the appliance has not only a cleansing effect, but a massage sensation which is satisfactory to the user, particularly at the conclusion of the cleansing action.

Although a preferred embodiment has been disclosed for purposes of illustration, it should be understood that various changes, modifications and substitutions may be incorporated in the preferred embodiment without departing from the spirit of the invention as defined by the claims which follow:

What is claimed is:

1. A skin cleansing appliance, comprising;
a driving assembly;
a head portion having a base member which is attachable to the driving assembly;
the head portion further having a flexible applicator assembly for holding a skin formulation;
a driving assembly for moving the head portion back and forth producing an action on the skin, stretching the skin in the skin depth direction; and
further for oscillating the head portion when the flexible applicator assembly is in contact with the skin.

2. The appliance of claim 1, wherein the head portion oscillates at a frequency in the range of 150-170 Hz and an amplitude in the range of 8°-12°.

3. The appliance of claim 1, wherein the end of the flexible applicator assembly is doughnut shaped.

4. The appliance of claim 1, including a plurality of flexible application assemblies mounted on the base member.

5. The appliance of claim 1, wherein the plurality of flexible application assemblies are independently controllable.

6. The appliance of claim 1, wherein the flexible member is a sponge material.

7. The appliance of claim 1, wherein the flexible member is rubber.

8. The appliance of claim 2, wherein the time duration of the tapping action is approximately the same as the time duration of the oscillation action.

9. The appliance of claim 1, wherein the end surface of the head flexible applicator assembly is configured to fit around a selected portion of a user's face.

10. The appliance of claim 9, wherein the selected portion is the user's nose.

11. The appliance of claim 10, including at least one spring member in the flexible application portion.
